(19) United States
(12) Patent Application Publication
(10) Pub. No.: US 2026/0078244 A1
(43) Pub. Date: Mar. 19, 2026

(54) THERMOPLASTIC STARCH WITH ENHANCED ADHESION CHARACTERISTICS

(71) Applicant: Winpak Ltd., Winnipeg (CA)

(72) Inventors: Mustafa Bilgen, Fayettville, GA (US); Sam Grimshaw, Winnipeg (CA); Mehdi Rafei, Winnipeg (CA); Ronald Asmundson, Winnipeg (CA)

(73) Assignee: Winpak Ltd., Winnipeg, MB (CA)

(21) Appl. No.: 18/887,609

(22) Filed: Sep. 17, 2024

(51) Int. Cl. C08L 3/02; B29C 48/00; B29C 48/08; B29C 48/21; B29K 23/00; B29K 67/00; B29K 105/00; B29L 31/00; B32B 27/08; B32B 27/22; B32B 27/30; B32B 27/32; B32B 27/36; B65D 65/40

(52) U.S. Cl. CPC C08L 3/02; B29C 48/022; B29C 48/08; B29C 48/21; B32B 27/08; B32B 27/22; B32B 27/306; B32B 27/32; B32B 27/36; B65D 65/40; B29K 2003/00; B29K 2023/083; B29K 2067/046; B29K 2105/0038; B29K 2105/0097; B29K 2995/0097; B29L 2031/712; B32B 2307/748; B32B 2439/70

(57) ABSTRACT

A thermoplastic packaging material composition is provided. The thermoplastic packaging material composition includes from about 30 wt % to 96 wt % of a starch, from about 1 wt % to 60 wt % of a plasticizer, and from about 0.05 wt % to 10 wt % of an adhesion promoter. The adhesion promoter may comprise an amine functional polymer, such as polyethylenimine (PEI). A multilayer packaging article may also be provided. The multilayer packaging article comprises at least a first layer formed from the thermoplastic packaging material composition described above. The multilayer packaging article further may include a second layer adhered to the first layer. The second layer may comprise a thermoplastic resin. The multilayer packaging article may further include a third layer adhered to the second layer. The third layer may comprise a thermoplastic resin such as polyester.

### FIELD OF THE DISCLOSURE

The present disclosure is generally directed to a thermoplastic starch with enhanced adhesion characteristics.

### BACKGROUND

Starch is a commonly available renewable polymer. For some applications, starch may be chemically and/or physically altered from a raw starch to a thermoplastic starch (TPS). The resulting thermoplastic starch can be used in a wide array of applications, such as a layer within a multi-layer composite article for any type of packaging including, but not limited to, a thermoplastic tray. As thermoplastic starch can absorb moisture leading to degradation, a protective layer is required to protect the thermoplastic starch layer from moisture. However, thermoplastic starch layers typically have insufficient adhesion characteristics to attach to such a protective layer.

### SUMMARY OF THE DISCLOSURE

The present disclosure provides a thermoplastic starch (TPS) with enhanced adhesion characteristics for use in packaging application, such as food packaging articles. The thermoplastic starch is formed from a composition comprising at least a starch, a plasticizer, and an adhesion promoter. The adhesion promoter comprises an amine functional polymer, such as polyethylenimine (PEI). The components of the composition are either premixed and heated as a batch or are fed directly into an extruder in various feeding zones. The mixture is then extruded to form a thermoplastic starch layer (a first layer) with enhanced adhesion characteristics. In particular, the mixture may be coextruded with other materials to form a multilayer packaging material. The first layer may be adhered to a second layer functioning as a tie layer to couple the first layer to an additional layer. The second layer may comprise a thermoplastic resin. The tie layer may be adhered to a third layer comprising a polymer that protects TPS from environmental factors such as moisture. Accordingly, this third layer may form a water-resistant barrier protecting the first, thermoplastic starch layer from moisture.

The raw starches used to form the composition may be any type of starch, such as potato starch, pea starch, wheat starch, tapioca starch, rice starch, arrowroot starch, mung bean starch, kudzu starch, sweet potato starch, and/or corn starch. In some examples, the composition may be from about 30 wt % to 96 wt % of starch, from about 1 wt % to 60 wt % of plasticizers, and from about 0.05 wt % to 10 wt % of an adhesion promoter. The protective material of the third layer may be a thermoplastic polyester, such as a polylactic acid (PLA). In some examples, the multilayer packaging material may include a second tie layer and a second water-resistant barrier layer to protect both sides of the thermoplastic starch layer. The plasticizer may include citric acid, glycerol, sorbitol, and/or water. In some examples, an adhesive bond strength between the first (thermoplastic starch) layer and the second (tie) layer may be at least 10 g/cm.

Generally, in one aspect, a thermoplastic packaging material composition is provided. The thermoplastic packaging material composition includes from about 30 wt % to 96 wt % of a starch.

The thermoplastic packaging material composition further includes from about 1 wt % to 60 wt % of a plasticizer.

The thermoplastic packaging material composition further includes from about 0.05 wt % to 10 wt % of an adhesion promoter.

In some embodiments, the adhesion promoter comprises an amine functional polymer.

In some embodiments, the amine functional polymer is PEI.

In some embodiments, the thermoplastic packaging material composition comprises from about 0.1 wt % to 3 wt % of the adhesion promoter.

In some embodiments, the starch comprises potato starch, green pea starch, wheat starch, tapioca starch, rice starch, arrowroot starch, mung bean starch, kudzu starch, sweet potato starch, and/or corn starch.

In some embodiments, the plasticizer comprises citric acid, glycerol, water and/or sorbitol.

Generally, in another aspect, a multilayer packaging article is provided. The multilayer packaging article comprises at least a first layer formed from the thermoplastic packaging material composition described above.

In some embodiments, the multilayer packaging article is a food packaging article.

In some embodiments, the multilayer packaging article further includes a second layer adhered to the first layer. A bond strength between the first layer and the second layer is at least 10 g/cm.

Generally, in another aspect, a method for forming a multilayer packaging article is provided. The method includes forming a mixture from a thermoplastic packaging material composition comprising a starch, a plasticizer, and an adhesion promoter.

The method further includes heating the mixture to a first temperature.

The method further includes coextruding the mixture and a second layer material to form the multilayer packaging article.

In some embodiments, the second layer material comprises polyethylene resin, polystyrene resin, ethylene vinyl acetate resin, polylactic acid resin, ethylene vinyl alcohol resin, poly vinyl alcohol resin, polyhydroxyalkanoate resin, polybutylene succinate resin, cellulose acetate resin, polypropylene resin, polyester resin, polyamide resin, and/or combinations thereof.

In some embodiments, the starch, the plasticizer, and the adhesion promoter are separately fed into an extruder prior to forming the mixture. The mixture may be formed within the extruder.

Generally, in another aspect, a multilayer packaging article is provided. The multilayer packaging article includes a first layer formed from a thermoplastic packaging material composition. The thermoplastic packaging material composition comprises (1) from about 30 wt % to 96 wt % of a starch; (2) from about 1 wt % to 60 wt % of a plasticizer; and (3) from about 0.05 wt % to 10 wt % of an adhesion promoter.

The multilayer packaging article further includes a second layer adhered to the first layer, wherein the second layer comprises a thermoplastic resin.

In some embodiments, the thermoplastic resin comprises polyethylene resin, polystyrene resin, ethylene vinyl acetate resin, polylactic acid resin, ethylene vinyl alcohol resin, poly vinyl alcohol resin, polyhydroxyalkanoate resin, polybutylene succinate resin, cellulose acetate resin, polypropylene resin, polyester resin, polyamide resin, and/or combinations thereof.

In some embodiments, a bond strength between the first layer and the second layer is at least 10 g/cm.

In some embodiments, the multilayer packaging article further includes a third layer adhered to the second layer, wherein the third layer comprises a thermoplastic polyester.

In some embodiments, the thermoplastic polyester is a polylactic acid.

In some embodiments, the multilayer packaging article further includes a fourth layer adhered to the first layer. The fourth layer may comprise the thermoplastic resin.

In some embodiments, the multilayer packaging article further comprises a fifth layer adhered to the fourth layer. The fifth layer may comprise the thermoplastic polyester.

In some embodiments, the thermoplastic resin comprises ethylene-vinyl acetate.

In some embodiments, the multilayer packaging article is a sheet, film, molding, or forming.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a front cross-sectional view of a multilayer packaging article, according to the present disclosure.

FIG. 2 is a front cross-sectional view of a further example of a multilayer packaging article, according to the present disclosure.

FIG. 3 is a front cross-sectional view of an even further example of a multilayer packaging article, according to the present disclosure.

FIG. 4 is a flow chart of a method for forming a multilayer packaging article, according to the present disclosure.

### DETAILED DESCRIPTION OF EMBODIMENTS

The present disclosure provides a thermoplastic starch (TPS) with enhanced adhesion characteristics for use in packaging application, such as food packaging articles. The thermoplastic starch is formed from a composition comprising at least a starch, a plasticizer, and an adhesion promoter. The composition may also contain water, such as either absorbed moisture in the starch or as an additive. The adhesion promoter includes an amine functional polymer, such as polyethylenimine (PEI). The components of the composition are either premixed and heated as a mixture or fed directly into an extruder at various locations. The mixture is then extruded to form a first layer of thermoplastic starch having enhanced adhesion characteristics. In particular, the mixture may be coextruded with other materials to form a multilayer packaging material. The first layer may be adhered to a second layer functioning as a tie layer to couple the first layer to an additional layer. The second layer may comprise a thermoplastic resin. The tie layer may be adhered to a third layer comprising protective material. Accordingly, this third layer forms a barrier protecting the first, thermoplastic starch layer from environmental factors such as moisture.

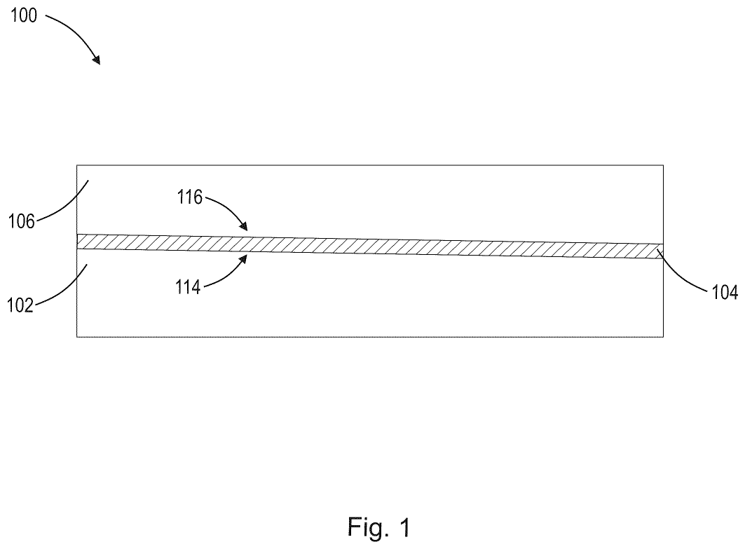

FIG. 1 is a front cross-sectional view of a non-limiting example of a multilayer packaging article 100. The multilayer packaging article 100 may be a food packaging article, such as a sheet, film, molding, or forming. The food packaging article may be a component of a food package, such as a cup, tube, packet, pouch, lidding film, and/or the like. In some embodiments, the food package may be single use. In particular embodiments, the food product can comprise a solid, a liquid, and/or a semi-liquid foodstuff. For example, in some embodiments, the food product can include, but is not limited to, meat, cheese, pasta, yogurt, a condiment, a dip, a sauce, a dressing, and/or the like.

The non-limiting example of the multilayer packaging article 100 in FIG. 1 includes a first layer 102. The first layer 102 is formed from a thermoplastic packaging material composition. As will be described in greater detail below, the thermoplastic packaging material composition primarily comprises a starch, thereby forming a thermoplastic starch (TPS). Accordingly, the first layer 102 may also be referred to as a TPS layer. The TPS layer provides a number of advantages over existing thermoplastics, such as being formed from a renewable material as well as being biodegradable. However, TPS is susceptible to absorbing moisture, such as from the contents of the food package. This moisture can degrade the TPS layer, which can threaten the integrity of the food package. Accordingly, an adhesive second layer 104 is used to attach a protective third layer 106 to the TPS layer, thereby preventing the TPS layer from getting absorbing moisture. As described herein, the second layer 104 may be referred to as a first tie layer, while the third layer 106 may be referred to as a first cap layer. Accordingly, if the multilayer packaging article 100 is a component of a food package, the third layer 106 may face the inner volume of the package to protect the first layer 102 from the contents inside the package. The first layer 102 may have a thickness ranging from about 10 microns to about 1000 microns, including about 10 microns, about 25 microns, about 50 microns, about 75 microns, about 100 microns, about 200 microns, about 300 microns, about 400 microns, about 500 microns, about 600 microns, about 700 microns, about 800 microns, about 900 microns, and/or about 1000 microns, as well as any ranges formed from these values.

Broadly, the thermoplastic packaging material composition forming the first layer 102 comprises or consists essentially of three components: (1) the starch, (2) a plasticizer, and (3) an adhesion promoter. The first layer 102 is created by forming a mixture of the thermoplastic packaging material composition (i.e., the starch, the plasticizer, and the adhesion promoter) along with one or more liquids. In some examples, a powder form of the starch is initially combined with water. The plasticizer and the adhesion promoter are then mixed together and subsequently injected into the mixture. Once formed, the mixture is then heated to at least a first temperature to create a gelled version of the mixture. In some examples, the first temperature is a boiling point of the mixture. In some examples, the first temperature ranges from about 60° C. to about 200° C. In preferred examples, the first temperature ranges from about 90° C. to 170° C., including about 90° C., about 100° C., about 110° C., about 120° C., about 130° C., about 140° C., about 150° C., about 160° C., and/or about 170° C., as well as any ranges formed from these values. Following heating, the gelled mixture is then extruded via a die to form the first layer 102 as a flat sheet. In some examples, the first layer 102 is coextruded with one or more other layers (e.g., layers 104, 106, 108, 110 shown in FIG. 1) to form the multilayer packaging article 100. However, in other examples, the first layer 102 could be extruded separately from one or more of the other layers 104, 106, 108, 110.

In some further examples, the starch, the plasticizer, and the adhesion promoter are separately and directly fed into the extruder using one or more feeding zones. The starch, the plasticizer, and the adhesion promoter are then mixed and heated within the extruder prior to the extrusion forming the first layer 102. In even further examples, two of the starch, the plasticizer, and the adhesion promoter may be mixed together outside of the extruder before mixing with the other component within the extruder.

The thermoplastic packaging material composition may comprise from about 30 wt % to 96 wt % of the starch, including about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, and/or about 96 wt % of the starch, as well as any ranges formed from these amounts. Preferably, the thermoplastic packaging material composition may comprise from about 60 wt % to 80 wt % of the starch. The starch may comprise potato starch, pea starch, wheat starch, tapioca starch, rice starch, arrowroot starch, mung bean starch, kudzu starch, sweet potato starch, and/or corn starch. In some applications, pea or potato starch may be preferred due to availability and cost. In further examples, the composition may include any type of starch capable of forming an extrudable layer of TPS.

The plasticizer is used to convert the starch into TPS. In some examples, the plasticizer comprises citric acid, glycerol, sorbitol, and/or water. In a preferred example, the plasticizer includes glycerol and sorbitol, and therefore does not require drying following extrusion of the TPS layer. In some other examples, water may be used as a plasticizer, but will need to be partially dried or otherwise removed from the TPS layer following extrusion to prevent the TPS layer from being tacky or sticky. The thermoplastic packaging material composition may comprise from about 1 wt % to 60 wt % of the plasticizer, including about 1 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, and/or about 60 wt % of the plasticizer, as well as any ranges formed from these amounts. Preferably, the thermoplastic packaging material composition comprises from about 15 wt % to 40 wt % of the plasticizer.

In this present application, the adhesion promoter is added to the thermoplastic material composition to improve bond strength between the first layer 102 and polymeric materials, such as the materials of the second layer 104. In some examples, the adhesion promoter is an amine functional polymer, such as polyethylenimine (PEI). Amine functional polymers are highly reactive, and, therefore, function as an adhesion promoter due to their chemical properties causing reactions with materials having reactive sites such as hydroxyl groups or maleic anhydride groups. In some examples, the PEI may be a linear or unbranched PEI, a branched PEI, a PEI ethoxylate, and/or the like. In some examples, the PEI may be a branched PEI having a polydispersity index (PDI) greater than or equal to 1.3. The example branched PEI may be product number 408727 available from Sigma Aldrich® having an average molecular weight (Mw) of about 25,000 as measured by light scattering (LS) and a number average molecular weight (Mn) of about 10,000 as measured by gel permeation chromatography (GPC). The thermoplastic packaging material composition may comprise from about 0.05 wt % to 10 wt % of the adhesion promoter, including about 0.05 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2.0 wt %, about 2.5 wt %, and/or about 3 wt % of the adhesion promoter, as well as any ranges formed from these amounts. Preferably, the thermoplastic packaging material composition comprises from about 0.1 wt % to 3 wt % of the adhesion promoter.

As described herein, it has been surprisingly found that PEI can significantly improve adhesion between polymeric materials when mixed into a starch-based thermoplastic packaging material. Starch is generally a highly polar polymer due to the presence of hydroxyl groups on polymer repeating units forming the starch. Therefore, the pre-experimental expectation was that PEI would be surrounded by polar starch polymer chains, thereby preventing the PEI from migrating to an interphase region between a thermoplastic starch layer (such as first layer 104) and a tie layer (such as second layer 106). However, experimentation led to observations and measurements of unexpected synergy between the starch, the plasticizer, the PEI, and the process for forming the thermoplastic starch that enables some amount of PEI to move towards the interphase region, thereby promoting adhesion between the thermoplastic starch layer and the tie layer. Accordingly, when mixed into a starch-based thermoplastic packaging material composition, PEI has been shown to significantly improve adhesion to other polymeric materials, such as, but not limited to, maleic anhydride grafted polyolefins.

In some embodiments, 100% pure PEI is initially mixed with the plasticizer, such as glycerol, while the starch is mixed into water. The PEI-plasticizer mixture is then combined with the starch-water mixture to create a mixture. The mixture is then heated and extruded to form the first layer 102.

The second layer 104 shown in FIG. 1 is an adhesive tie layer configured to affix the first layer 102 (the TPS layer) to the third layer 106 (the cap layer). The second layer 104 comprises a thermoplastic resin to enable affixing the first layer 102 to the third layer 106. The thermoplastic resin may be coextruded with the first layer 102. The thermoplastic resin may comprise polymeric materials such as polyethylene resin, polylactic acid resin, polyhydroxyalkanoate resin, polybutylene succinate resin, cellulose acetate resin, polypropylene resin, polyester resin, polyamide resin, copolymers of the aforementioned mentioned resins and/or combinations thereof. In a preferred example, the thermoplastic resin comprises a polyolefin-base material, such as polyethylene resin. Polyethylene resin may be preferred due to having high moisture barrier properties and generally being available at low cost. Any of the aforementioned resins may or may not contain maleic anhydride grafting. In further examples, the thermoplastic resin could be ethylene-vinyl acetate. The second layer 104 may have a thickness ranging from about 1 micron to about 100 microns, including about 1 micron, about 5 microns, about 10 microns, about 20 microns, about 30 microns, about 40 microns, about 50 microns, about 60 microns, about 70 microns, about 80 microns, about 90 microns, and/or about 100 microns, as well as any ranges formed from these values. Further, a first interface 114 of the multilayer packaging article 100 may be defined as an interface between the first layer 102 and the second layer 104.

In some examples, the second layer may comprise maleic anhydride grafted polyethylene resin, such as Bynel™ 21533 (available from The Dow Chemical Company). Accordingly, the adhesion promoter of the thermoplastic packaging material composition significantly improves adhesion between the first layer 102 and the second layer 104. In some examples of implementing the adhesion promoter in the first layer 102, a bond strength between the first layer 102 and the second layer 104 is at least about 10 grams per centimeter (g/cm) when measured according to the test method described in the Examples section below, such as at least about 10 g/cm, at least about 25 g/cm, at least about 50 g/cm, at least about 75 g/cm, at least about 100 g/cm, at least about 125 g/cm, at least about 150 g/cm, at least about 175 g/cm, and/or at least about 200 g/cm, as well as any ranges formed from these values. In some preferred examples, the bond strength between the first layer 102 and the second layer 104 is at least about 200 g/cm, including at least about 210 g/cm, at least about 220 g/cm, at least about 230 g/cm, at least about 240 g/cm, at least about 250 g/cm, and/or at least about 260 g/cm when measured according to the test method described in the Examples section below, as well as any ranges formed from these values. Generally, sufficient bond strength between adjacent layers is important during handling and usage of a packaging article, such as the multilayer packaging article 100 shown in FIG. 1. The minimum required bond strength varies per application, but, generally, the bond strength between adjacent layers must be at least 20 g/m to survive mild handling.

The third layer 106 shown in FIG. 1 is a protective cap layer configured to be affixed to the second layer 104. The third layer 106 is configured to protect the TPS material of the first layer 102 from absorbing moisture, which may threaten the integrity of the first layer 102 and the multilayer packaging article 100 as a whole. Accordingly, the third layer 106 may comprise a water insoluble material, resulting in a water-proof or water-resistant layer. In some examples, the multilayer packaging article 100 may be used to form a pouch for liquid and/or solid foodstuffs. The third layer 106 may be orientated to face the interior of the pouch, thereby protecting TPS first layer 102 from moisture from the foodstuffs within the pouch. In some examples, the third layer 106 includes a thermoplastic resin, such as polyester. In some examples, the polyester may be polylactic acid. The protective cap third layer 106 may be coextruded with the first layer 102 and the second layer 104. The third layer 106 may have a thickness ranging from about 5 microns to about 500 microns, including about 5 microns, about 25 microns, about 50 microns, about 75 microns, about 100 microns, about 150 microns, about 200 microns, about 250 microns, about 300 microns, about 350 microns, about 400 microns, about 450 microns, and/or about 500 microns. Further, a second interface 116 of the multilayer packaging article 100 may be defined as an interface between the second layer 104 and the third layer 106.

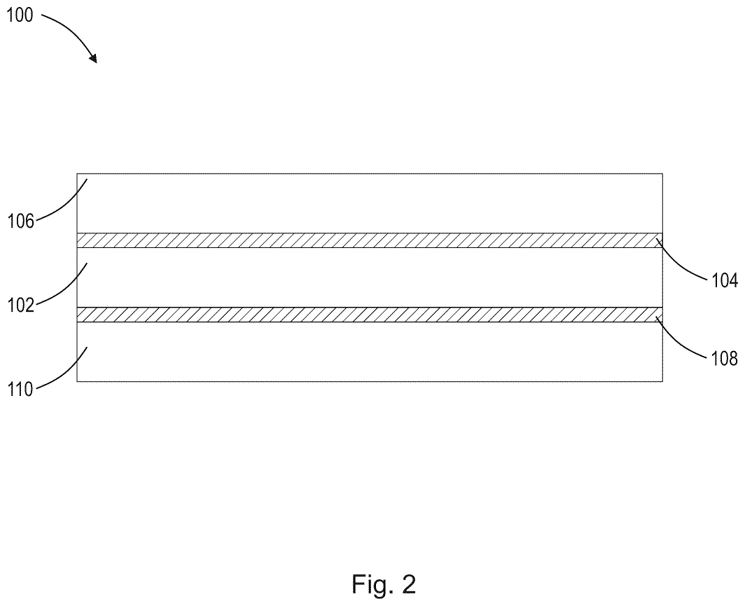

FIG. 2 is a front cross-sectional view of a further example of a multilayer packaging article 100. The multilayer packaging article 100 of FIG. 2 includes the first layer 102, the second layer 104, and the third layer 106 as described in reference to FIG. 1. As illustrated in FIG. 2, an adhesive fourth layer 108 may also be used to attach a protective fifth layer 110 to the first layer 102. Like the second layer 104, the fourth layer 108 may be considered a second tie layer comprising thermoplastic resin to attach the fifth layer 110 to the TPS first layer 102. Further, like the third layer 106, the fifth layer 110 may be considered a second protective cap layer comprising thermoplastic polyester to protect the TPS first layer 102 from moisture. For example, if the multilayer packaging article 100 is a component of a food pouch, the fifth layer 110 may face the exterior environment to protect the first layer 102 from various environmental aspects, such as moisture on the user's hands, while the third layer 106 protects the first layer 102 from the internal contents of the food pouch. The total number of layers can further increase to accordingly to the desired functionality or strength of the multilayer packaging article 100.

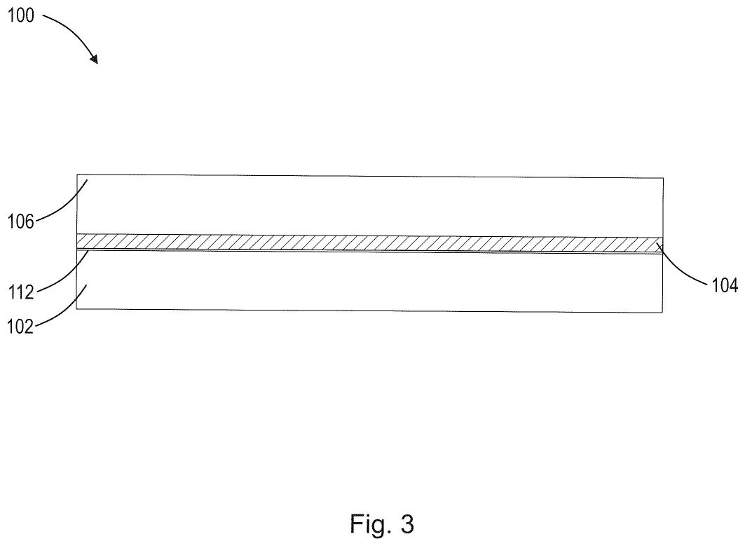

FIG. 3 shows another example of a multilayer packaging article 100. In this example, the first layer 102 is formed (such as via extrusion) from a variation of the thermoplastic packaging material composition which includes the starch and the plasticizer, but does not include the adhesion promoter. In this example, the adhesion promoter (such as PEI) is mixed with water and applied to the first layer 102 as a liquid coating. Once the liquid coating dries, a primer layer 112 remains to improve adhesion between the first layer 102 and the second layer 104, which may be an adhesive tie layer. As with the previous examples, the second layer 104 is used to affix the protective third layer 106 to the first layer 102 to prevent the first layer 102 from absorbing moisture.

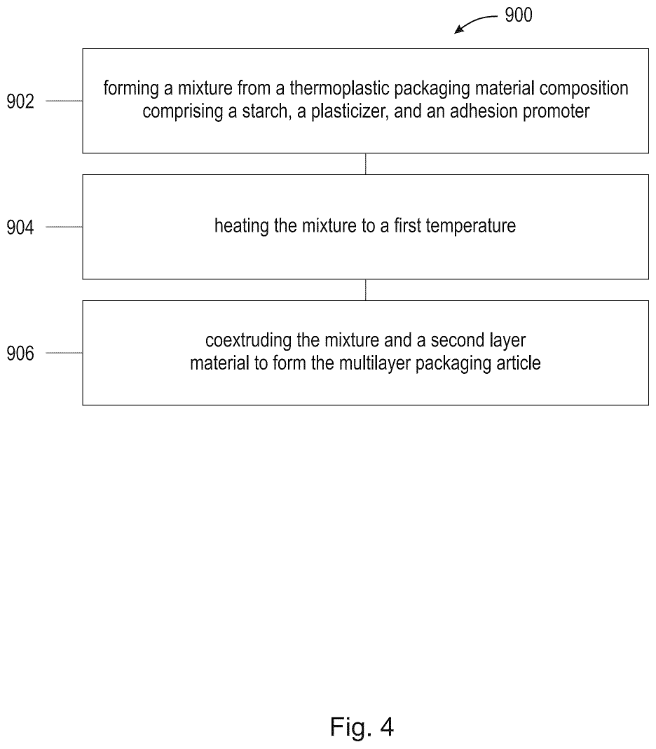

FIG. 4 is a flowchart of a method 900 for forming a multilayer packaging article 100. With reference to FIGS. 1-4, the method 900 includes, in step 902, forming a mixture from a thermoplastic packaging material composition comprising a starch, a plasticizer, and an adhesion promoter.

The method 900 further includes, in step 904, heating the mixture to a first temperature.

The method 900 further includes, in step 906, coextruding the mixture and a second layer material to form the multilayer packaging article.

### EXAMPLES

Trials were performed on an embodiment of the multilayer packaging article 100 of FIG. 1 to demonstrate the improved adhesion between the TPS first layer 102 and the tie second layer 104. In these trials, the first layer 102 was formed from a thermoplastic packaging material composition of 66 to 68 wt % of starch, 32 wt % of plasticizer, and 0 wt % to 2 wt % of adhesion promoter, such that any amount of added adhesion promoter reduced the amount of starch percentage by the same amount (for example, 66 wt % starch plus 32 wt % plasticizer plus 2 wt % adhesion promoter equaling 100% or 64.5 wt % starch plus 32 wt % plasticizer plus 0.5 wt % adhesion promoter equaling 100%). The first layer 102 had a thickness ranging from 325 to 465 microns. In this example, the second layer 104 comprises maleic anhydride grafted polyethylene resin (commercially available as Bynel™ 21E533 from The Dow Chemical Company). The second layer 104 has a thickness ranging from 80 to 145 microns. Further to this example, the first layer 102 comprises various amounts of PEI as the adhesion promoter. The PEI used in this example was a branched PEI. Additionally, the third layer 106 comprises a thermoplastic resin in the form of polylactic acid (commercially available as Ingeo™ Biopolymer 2500HP from Nature Works). The third layer 106 has a thickness ranging from 70 to 185 microns. The multilayer packaging article 100 was formed by coextruding the first layer 102, the second layer 104, and the third layer 106 using cast extrusion equipment, such that the second layer 104 affixes the first layer 102 to the third layer 106. Further, the first interface 114 of the multilayer packaging article 100 is defined as an interface between the first layer 102 and the second layer 104, and the second interface 116 of the multilayer packaging article 100 may be defined as an interface between the second layer 104 and the third layer 106.

The adhesion properties of the multilayer packaging article 100 were tested according to the following method. A sample of the multilayer packaging article 100 was formed by cutting a rectangular strip that was 2 cm wide and no more than 20 cm long. The two interfaces 114, 116 are initially manually evaluated to determine which interface 114, 116 is weakest. This interface 114, 116 is then carefully pried open. The layers 102, 104, 106 forming the weakest interface 114, 116 are then partially pulled apart over a length exceeding an initial distance between jaw clamps of a testing machine. In this example, an Instron machine was used to measure the bond strength between the layers 102, 104, 106 of the multilayer packaging article 100. The Instron machine had an upper jaw clamp and a lower jaw clamp initially spaced 2.5 cm apart. The upper jaw clamp then engaged one of the layers 102, 104, 106 forming the weakest interface 114, 116, while the lower jaw clamp engaged the other layer 102, 104, 106. The upper and lower jaw clamps then moved apart at a rate of approximately 150 millimeters per minute while measuring peel displacement (in millimeters) and force-load (in gram-force). An average, force-load was determined by averaging force-load measurements captured over peel displacements between 5 millimeters and 15 millimeters. The interlayer bond strength (gram-force per cm) was then calculated by dividing the average force-load measurement by the width of the sample (2 cm in this example). Testing was performed on multilayer packaging articles 100 having four different amounts of PEI in the first layer 102. For each PEI amount, five multilayer packaging articles 100 formed from the same batch were pulled apart. The test results are shown in Table 1 below.

TABLE 1
Bond Strength of Packaging Articles with
Varying Amounts of Adhesion Promoter

| PEI | Bond Strength | Layer | Average |
|---|---|---|---|
| Content | at Split | Interface Split | Bond Strength |
| (wt %) | (g/cm) | (failure location) | (g/cm) |
| 0% PEI | 0 | TIE/TPS | 0.0 |
| 0% PEI | 0 | TIE/TPS | |
| 0% PEI | 0 | TIE/TPS | |
| 0% PEI | 0 | TIE/TPS | |
| 0% PEI | 0 | TIE/TPS | |
| 0.5% PEI | 201 | PLA/TIE | 203.0 |
| 0.5% PEI | 183 | PLA/TIE | |
| 0.5% PEI | 196 | PLA/TIE | |
| 0.5% PEI | 202 | PLA/TIE | |
| 0.5% PEI | 233 | PLA/TIE | |
| 1% PEI | 255 | PLA/TIE | 264.8 |
| 1% PEI | 264 | PLA/TIE | |
| 1% PEI | 287 | PLA/TIE | |
| 1% PEI | 250 | PLA/TIE | |
| 1% PEI | 268 | PLA/TIE | |
| 2% PEI | 236 | PLA/TIE | 265.6 |
| 2% PEI | 273 | PLA/TIE | |
| 2% PEI | 225 | PLA/TIE | |
| 2% PEI | 280 | PLA/TIE | |
| 2% PEI | 314 | PLA/TIE | |

In Table 1 above, TIE/TPS indicates a split between the first layer 102 and the second layer 104, while PLA/TIE indicates a split between the second layer 104 and the third layer 106. Thus, if a PLA/TIE split occurs during testing, the bond strength value of the TIE/TPS bond must be greater than the measured value of the bond strength during the PLA/TIE split.

As shown in Table 1, a zero (0) bond strength was demonstrated in the five samples having no PEI as the first layer 102 was pulled apart from the second layer 104. In these examples, a bond strength of zero means that the second layer 104 slid off of the first layer 102 without measurable resistance. At 0.5% PEI, a 203.0 g/cm average bond strength was measured when the second layer 104 separated from the third layer 106, meaning that the bond strength between the first layer 102 and the second layer 104 was greater than 203.0 g/m. At 1.0% PEI, a 264.8 g/cm average bond strength was measured when the second layer 104 separated from the third layer 106, meaning that the bond strength between the first layer 102 and the second layer 104 was greater than 264.8 g/m. At 2.0% PEI, a 265.6 g/cm average bond strength was measured when the second layer 104 separated from the third layer 106, meaning that the bond strength between the first layer 102 and the second layer 104 was greater than 265.6 g/m. Accordingly, adding PEI to the thermoplastic packaging material composition to be extruded as the first layer 102 significantly improved adhesion between the first layer 102 and the second layer 104.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A thermoplastic packaging material composition, comprising:
from about 30 wt % to 96 wt % of a starch;
from about 1 wt % to 60 wt % of a plasticizer; and
from about 0.05 wt % to 10 wt % of an adhesion promoter.

2. The thermoplastic packaging material composition of claim 1, wherein the adhesion promoter comprises an amine functional polymer.

3. The thermoplastic packaging material composition of claim 2, wherein the amine functional polymer is polyethyleneimine (PEI).

4. The thermoplastic packaging material composition of claim 1, wherein the thermoplastic packaging material composition comprises from about 0.1 wt % to 3 wt % of the adhesion promoter.

5. The thermoplastic packaging material composition of claim 1, wherein the starch comprises potato starch, green pea starch, wheat starch, tapioca starch, rice starch, arrowroot starch, mung bean starch, kudzu starch, sweet potato starch, and/or corn starch.

6. The thermoplastic packaging material composition of claim 1, wherein the plasticizer comprises citric acid, glycerol, water, and/or sorbitol.

7. A multilayer packaging article, comprising at least a first layer formed from the thermoplastic packaging material composition of claim 1.

8. The multilayer packaging article of claim 7, wherein the multilayer packaging article is a food packaging article.

9. The multilayer packaging article of claim 7, further comprising a second layer adhered to the first layer, wherein a bond strength between the first layer and the second layer is at least 10 g/cm.

10. A method for forming a multilayer packaging article, comprising:
forming a mixture from a thermoplastic packaging material composition comprising a starch, a plasticizer, and an adhesion promoter;
heating the mixture to a first temperature; and
coextruding the mixture and a second layer material to form the multilayer packaging article.

11. The method of claim 10, wherein the second layer material comprises polyethylene resin, polystyrene resin, ethylene vinyl acetate resin, polylactic acid resin, ethylene vinyl alcohol resin, poly vinyl alcohol resin, polyhydroxyalkanoate resin, polybutylene succinate resin, cellulose acetate resin, polypropylene resin, polyester resin, polyamide resin, and/or combinations thereof.

12. The method of claim 10, wherein, the starch, the plasticizer, and the adhesion promoter are separately fed into an extruder prior to forming the mixture, and wherein the mixture is formed within the extruder.

13. A multilayer packaging article, comprising:
a first layer formed from a thermoplastic packaging material composition, wherein the thermoplastic packaging material composition comprises:
from about 30 wt % to 96 wt % of a starch;
from about 1 wt % to 60 wt % of a plasticizer; and
from about 0.05 wt % to 10 wt % of an adhesion promoter; and
a second layer adhered to the first layer, wherein the second layer comprises a thermoplastic resin.

14. The multilayer packaging article of claim 13, wherein the thermoplastic resin comprises polyethylene resin, polystyrene resin, ethylene vinyl acetate resin, polylactic acid resin, ethylene vinyl alcohol resin, poly vinyl alcohol resin, polyhydroxyalkanoate resin, polybutylene succinate resin, cellulose acetate resin, polypropylene resin, polyester resin, polyamide resin, and/or combinations thereof.

15. The multilayer packaging article of claim 13, wherein a bond strength between the first layer and the second layer is at least 10 g/cm.

16. The multilayer packaging article of claim 13, further comprising a third layer adhered to the second layer, wherein the third layer comprises a thermoplastic polyester.

17. The multilayer packaging article of claim 16, wherein the thermoplastic polyester is a polylactic acid.

18. The multilayer packaging article of claim 16, further comprising:
a fourth layer adhered to the first layer, wherein the fourth layer comprises the thermoplastic resin; and
a fifth layer adhered to the fourth layer, wherein the fifth layer comprises the thermoplastic polyester.

19. The multilayer packaging article of claim 13, wherein the thermoplastic resin comprises ethylene-vinyl acetate.

20. The multilayer packaging article of claim 13, wherein the multilayer packaging article is a sheet, film, molding, or forming.
